(19) United States
(12) Patent Application Publication
(10) Pub. No.: US 2026/0074636 A1
(43) Pub. Date: Mar. 12, 2026

(54) CURRENT SENSING AND MOTOR CONTROL

(71) Applicant: Infineon Technologies Austria AG, Villach (AT)

(72) Inventors: Tao Zhao, Redondo Beach, CA (US); Vatche OKNAIAN, Henderson, NV (US)

(21) Appl. No.: 18/883,252

(22) Filed: Sep. 12, 2024

(51) Int. Cl. H02P 21/22; H02P 25/18

(52) U.S. Cl. CPC H02P 21/22; H02P 25/182; H02P 2201/13; H02P 2205/01

(57) ABSTRACT

A controller associated with a power supply determines a first ratio value. The first ratio value may be a ratio of a second time duration with respect to a first time duration, where the second time duration is a measured time duration associated with demagnetizing of a transformer in a first control cycle. The first time duration may be a measured time duration of activating a first switch in the first control cycle, where activation of the first switch operative to control a magnitude of primary current through a primary winding of the transformer. For second control cycle occurring subsequent to the first control cycle, the controller calculates an ON-time duration for activating the second switch based on the determined first ratio value.

### BACKGROUND

According to conventional techniques, shunt DC-link current sensing is commonly used in three-phase BLDC/PMSM and H-bridge motor controls. A conventional three-phase motor control circuit can be configured to include a so-called shunt resistor and a corresponding amplifier to determine a magnitude of current through a switch in corresponding circuit path. The conventional shunt resistor occupies circuit board space, dissipates heat, and is costly. For FOC (Field-Oriented Control) implementations, which require accurate three-phase current construction, the corresponding amplifier associated with the shunt resistor needs to have a wide bandwidth and high slew-rate due to the ADC sampling windows being narrow, especially at the SVM (Space Vector Modulation) borders and low motor speed. To solve this problem, three-shunt current sensing or in-line current sensing can be implemented in a motor control system.

### BRIEF DESCRIPTION

This disclosure includes the observation that conventional in-phase shunt current sensing needs special current sense amplifiers with wide common-mode range and enhanced PWM (Pulse Width Modulation) rejection. More such shunt resistors in parallel are needed for high power applications, so for in-line current sensing and three-shunt current sensing, the conventional implementation of current sensing significantly increases the PCB (Printed Circuit Board) size and BOM (Bill Of Material) cost. It is also difficult to precisely measure a respective current through a switch circuit using the conventional shunt resistor.

Techniques as discussed herein include novel ways of providing improved sensing of current through the circuit path including switch circuitry.

More specifically, an apparatus as discussed herein includes first switch circuitry and a monitor circuit. The first switch circuitry can be configured to include a first node and a second node. In one example, the first node is operative to receive first current. The first switch circuitry is operative to control conveyance of the first current received at the first node through the first switch circuitry and out the second node of the first switch circuitry. The monitor circuit is configured to: i) receive a first signal outputted from a third node of the first switch circuitry, and ii) produce a second signal indicative of a magnitude of the first current.

In one example, the first signal outputted from the first switch circuitry is a second current: i) received at the first node of the first switch circuitry, ii) conveyed through the first switch circuitry during a condition in which the first switch circuitry is ON, and iii) outputted from the third node to the monitor circuit. A magnitude of the second current may be proportional to a magnitude of the first current.

In further examples, the first switch circuitry may be a so-called cut-off switch or protection switch. Note that the first switch circuitry such as a so-called SenseFET may be used more like a protection switch rather than inrush current limiter device. Depending upon a state of the first switch circuitry, the first switch circuitry connects or disconnects an inverter from a battery source. For example, during a condition in which the first switch circuitry is operated in an OFF-state, the first switch circuitry disconnects the inverter from the battery resource. During a condition in which the first switch circuitry is operated in an ON-state, the first switch circuitry may connect the inverter to the battery resource.

Yet further, the first signal may be a second current proportional to the first current. The monitor circuit can be configured to produce the second signal based on a sample voltage produced by flow of the second current through a resistor. Additionally, the monitor circuit can be configured to include an analog-to-digital converter operative to convert the sample voltage into a digital value indicative of a magnitude of the first current.

In still further examples as discussed herein, the first signal is a second current in which a magnitude of the second current is proportional to a magnitude of the first current. The monitor circuit can be configured to include an amplifier circuit. The amplifier circuit can be configured to: i) convert the second current into a voltage signal, and ii) apply an offset to the voltage signal. The monitor circuit further may include: filter circuitry to filter the voltage signal; and an analog-to-digital converter operative convert the filtered voltage signal into a digital value indicative of a magnitude of the first current.

In yet another example as discussed herein, the first switch circuitry may be disposed in series with second switch circuitry. The second switch circuitry can be configured to control conveyance of the first current through at least one winding of a motor. In such an instance, the second switch circuitry is configured to receive the first current from a voltage source and output the first current to the first node of the first switch circuitry. The apparatus as discussed herein may further include a capacitor disposed in parallel with the second switch circuitry. A combination of the capacitor and the second switch circuitry may be disposed in series with the first switch circuitry. Yet further, a capacitor may be disposed in parallel with a series combination of the first switch circuitry and the second switch circuitry.

The first switch circuitry as discussed herein may be configured to receive the first current at the first node from a voltage source and supply the first current through the second node to the second switch circuitry. The apparatus may include a capacitor disposed in parallel with the second switch circuitry. A parallel combination of the capacitor and the second switch circuitry may be disposed in series with the first switch circuitry.

Alternatively, a capacitor may be disposed in parallel with a series combination of the first switch circuitry and the second switch circuitry.

In further examples as discussed herein, the first switch circuitry may include: i) a first switch including a first gate node, a first drain node, and a first source node; ii) a second switch including a second gate node, a second drain node, and a second source node; and iii) an operational amplifier. The first gate node may be directly connected to the second gate node; the first drain node may be directly connected to the second drain node; the operational amplifier can be configured to generate the first signal outputted from the third node of the first switch circuitry based on a first voltage at the first source node and a second voltage at the second source node. Still further, the operational amplifier can be configured to operate in a buffer mode in which an output of the operational amplifier is directly connected to the second source node.

Yet further examples as discussed herein include a controller. The controller can be configured to control operation of: i) the first switch circuitry, and ii) second switch circuitry directly coupled to the first switch circuitry.

Yet another example as discussed herein includes a method comprising: receiving a first signal outputted from first switch circuitry, the first switch circuitry including a first node and a second node, the first switch circuitry operative to control conveyance of first current received at the first node of the first switch circuitry through the first switch circuitry and out the second node of the first switch circuitry, the first signal received from a third node of the first switch circuitry; and converting the received first signal into a second signal indicative of a magnitude of the first current.

Note that in addition to potentially being implemented as an analog controller and corresponding analog circuitry/components as described herein, examples herein include implementing the described circuitry via digital controller/monitor implementations. More specifically, note that any of the resources as discussed herein can include digital circuitry such as one or more computerized devices, apparatus, hardware, etc., that execute and/or support any or all of the method operations disclosed herein. In other words, one or more computerized devices or processors can be programmed and/or configured to operate as explained herein to carry out the different examples as described herein.

Yet other examples herein include software programs to perform the steps and/or operations summarized above and disclosed in detail below. One such example comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes a computer readable storage medium and/or system having instructions stored thereon to facilitate generation of an output voltage from a respective power supply. The instructions, when executed by computer processor hardware, cause the computer processor hardware to: receive a first signal outputted from first switch circuitry, the first switch circuitry including a first node and a second node, the first switch circuitry operative to control conveyance of first current received at the first node of the first switch circuitry through the first switch circuitry and out the second node of the first switch circuitry, the first signal received from a third node of the first switch circuitry; convert the received first signal into a second signal indicative of a magnitude of the first current.

The ordering of the operations above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

Note further that although examples as discussed herein are applicable to controlling operation of a power supply to generate an output voltage, the concepts disclosed herein may be advantageously applied to any other suitable voltage converter topologies.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques.

For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a current monitoring switch providing current flow control in a motor system as discussed herein.

FIG. 2 is a more detailed example diagram illustrating a current monitoring switch in corresponding monitor circuit as discussed herein.

FIG. 3 is an example diagram of a space vector modulation for motor control as discussed herein.

FIG. 4 is an example diagram illustrating pulse width modulation switch control and current sensing as discussed herein.

FIG. 5 is an example circuit diagram illustrating connectivity of switches, capacitors, and a battery associated with a switch/motor control circuit as discussed herein.

FIG. 6 is an example circuit diagram illustrating connectivity of switches, capacitors, and a battery associated with a switch/motor control circuit as discussed herein.

FIG. 7 is an example diagram illustrating implementation of a current monitor circuit in a motor control system as discussed herein.

FIG. 8 is an example diagram illustrating implementation of the current monitor circuit and a motor control system as discussed herein.

FIG. 9 is an example circuit diagram illustrating connectivity of switches, capacitors, and a battery associated with a switch control circuit as discussed herein.

FIG. 10 is an example circuit diagram illustrating connectivity of switches, capacitors, and a battery associated with a switch control circuit as discussed herein.

FIG. 11 is an example diagram illustrating a motor control system including a switch circuit as discussed herein.

FIG. 12 is an example diagram illustrating computer architecture operable to execute one or more operations according to examples herein.

FIG. 13 is an example diagram illustrating a method according to examples herein.

The foregoing and other objects, features, and advantages of examples herein will be apparent from the following more particular description herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

According to one example as discussed herein, an apparatus includes first switch circuitry and a monitor circuit. The first switch circuitry can be configured to include a first node and a second node. In one example, the first node is operative to receive first current. The first switch circuitry is operative to control conveyance of the first current received at the first node through the first switch circuitry and out the second node of the first switch circuitry. The first current may flow to or through a corresponding load. The monitor circuit is configured to: i) receive a first signal outputted from a third node of the first switch circuitry, and ii) produce a second signal indicative of a magnitude of the first current through the first switch circuitry and corresponding load.

Note that the determination of the winding current as discussed herein can be input method in any suitable applications such as three-phase motor control for BLDC, PMSM, ACIM (AC Induction Motor), H-bridge motor control, or other applications that need dc-link current sensing. Additionally, the control algorithms as discussed herein can be implemented in sensorless or sensored FOC applications, sensorless or sensored DTC (Direct Torque Control) applications, sensorless or sensored BLDC trapezoidal control applications, etc.

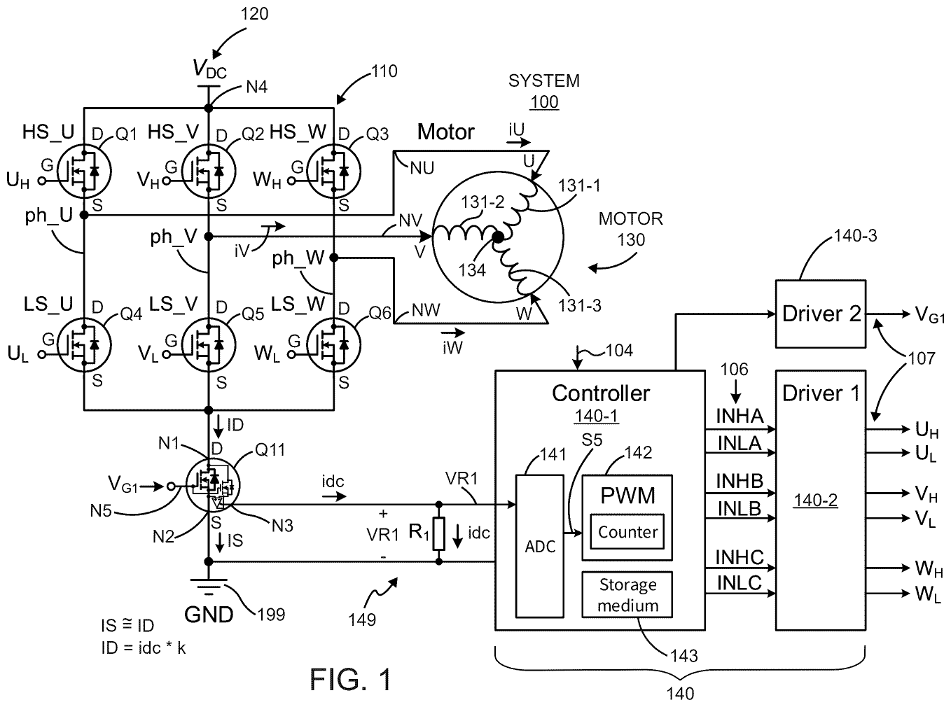

Now, more specifically, FIG. 1 is an example diagram illustrating a switch and corresponding monitor circuit supporting current flow control in a motor system as discussed herein.

In this example, the motor system 100 includes inverter 110, motor 130, switch Q11, monitor circuit 149, and controller 140.

The inverter 110 includes multiple switches such as switch Q1, switch Q2, switch Q3, switch Q4, switch Q5, and switch Q6.

Switch Q1 and switch Q4 are disposed in series between the node N4 and the node N1. For example, the drain node D of the switch Q1 is connected to the input voltage source 120 at node N4. As its name suggests, the input voltage source 120 supplies an input voltage VDC to the node N4 and corresponding drain node of the switch Q1. The source node S of the switch Q1 is directly connected to the drain node D of switch Q4 at node ph_U (or node NU). The source node S of switch Q4 is directly connected to the node N1 and corresponding drain node D of the switch Q11.

As further discussed herein, via generation of the control signal UH and the control signal UL, the controller 140 controls operation of each of the switches Q1, Q4, and Q11 to control a flow of current Iu supplied by inverter 110 to the winding 131-1 of motor 130. For example, the control signal UH controls operation of the switch Q1; the control signal UL controls operation of the switch Q4.

Switch Q2 and switch Q5 are disposed in series between the node N4 and the node N1. For example, the drain node D of the switch Q2 is connected to the input voltage source 120 at node N4. As its name suggests, the input voltage source 120 supplies an input voltage VDC to the node N4 and the corresponding drain node of the switch Q2. The source node S of the switch Q2 is directly connected to the drain node D of switch Q5 at node ph_V (node NV). The source node S of switch Q5 is directly connected to the node N1 and corresponding drain node D of the switch Q11.

As further discussed herein, via generation of the control signal VH and the control signal VL, the controller 140 controls operation of each of the switches Q2, Q5, and Q11 to control a flow of current Iv supplied by inverter to the winding 131-2 of motor 130. For example, the control signal VH controls operation of the switch Q2; the control signal VL controls operation of the switch Q5.

Switch Q3 and switch Q6 are disposed in series between the node N4 and the node N1. For example, the drain node D of the switch Q3 is connected to the input voltage source 120 at node N4. As its name suggests, the input voltage source 120 supplies an input voltage VDC to the node N4 and the corresponding drain node D of the switch Q3. The source node S of the switch Q3 is directly connected to the drain node D of switch Q6 at node ph_W (node NW). The source node S of switch Q6 is directly connected to the node N1 and corresponding drain node D of the switch Q11.

As further discussed herein, via generation of the control signal WH and the control signal WL, the controller 140 controls operation of each of the switches Q3, Q6, and Q11 to control a flow of current Iw supplied by inverter to the winding 131-3 of motor 130. For example, the control signal WH controls operation of the switch Q3; the control signal WL controls operation of the switch Q6.

Thus, the motor 130 includes any number of windings 131 such as winding 131-1, 131-2, and winding 131-3. As previously discussed, the controller 140 controls operation of the inverter 110 to control a flow of current through each of the multiple windings 131 of the motor 130.

As previously discussed, the motor system 100 includes the switch Q11. The source node S of the switch Q11 is directly connected to the node N1; the drain node D of the switch Q11 is directly connected the node N2; the gate node G of the switch Q11 is connected to node N5 and receives the corresponding control signal VG1 produced by the drive circuit 140-3; the node N3 is an output node of the switch Q11 and outputs a corresponding output signal such as current idc. The node N2 or drain node D of the switch Q11 is directly connected to ground reference voltage 199.

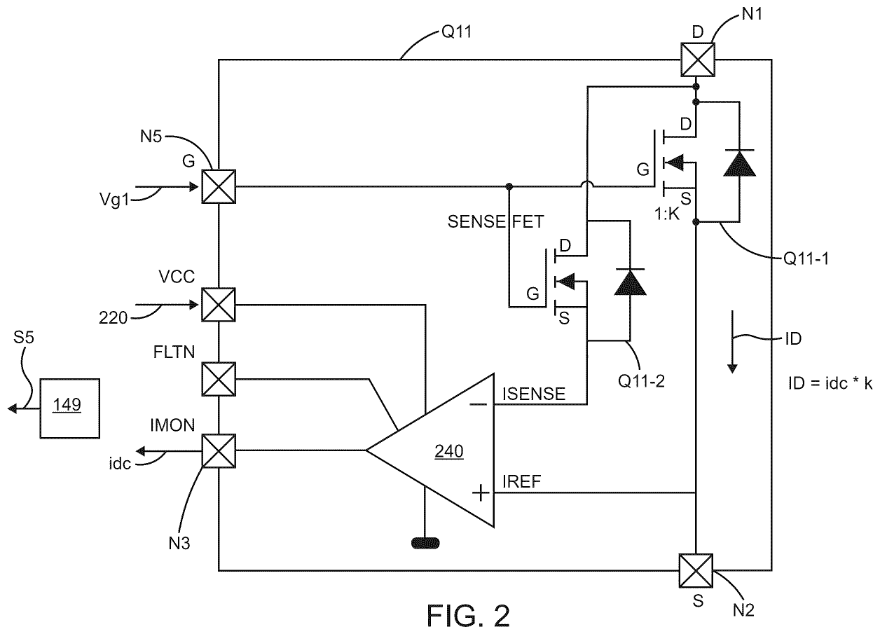

The controller 140 and corresponding circuitry generates the control signal VG1 to drive the gate node G (node N5) of the switch Q11. Details of the switch Q11 are further shown in FIG. 2. In general, when the switch Q11 is activated to an on state, the switch Q11 conveys received current ID through the switch Q11 to the node N2 in ground reference voltage 199. The magnitude of the current idc outputted from the node N3 of the switch Q11 is proportional to a magnitude of the current ID. For example, ID=idc*K, where K is a constant gain value such as 100, 1000, or any suitable value. Note that the current IS supplied by the from the source node S of the switch Q11 to the ground reference 199 is substantially equal to or equal to current ID.

The system 100 further includes the monitor circuit 149. The monitor circuit 149 includes any circuitry such as resistor R1, analog-to-digital converter 141, etc.

As further shown, the current idc outputted from the node N3 of the switch Q11 flows through the resistor R1 to produce the corresponding voltage VR1. The analog-to-digital converter 141 of the controller 140 receives voltage VR1. The magnitude of the voltage VR1 supplied to the analog-to-digital converter 141 of the controller 140 is equal to the magnitude of the current idc multiplied by the resistance associated with the resistor R1.

Still further, the controller 140 includes multiple components (hardware and/or software) such as analog-to-digital converter 141, counter 142, storage hardware 143, driver 140-2, and driver 140-3.

As its name suggests, the analog-to-digital converter 141 receives the voltage VR1 and converts the analog voltage VR1 into the digital signal S5. Digital signal S5 indicates a magnitude of the voltage VR1, which is used as a basis in which to determining a magnitude of the current idc as well as the magnitude of the current ID. Note again that the current IS supplied by the from the source node S of the switch Q11 to the ground reference 199 is substantially equal to or equal to current ID.

Note further that the controller 104 can be configured to receive the input control signal 104 indicating how to control operation of the motor 130. Based on receipt of feedback associated with the magnitude of current through the windings 131 as indicated by repeatedly monitoring a magnitude of the voltage VR1, the controller 140 produces the respective control signals 106, which in turn are converted into control signals 107 driving the switches in the inverter 110.

Thus, techniques herein include implementation of current sense switch Q11 (a.k.a., seventh switch or seventh field effect transistor) in place of a conventional dc-link resistor for current sensing in motor control. Measurement of the current ID through the switch Q11 is used as a basis in which to determine a magnitude of the current through each of the windings 131 of the motor 130.

Note that the switches associated with the inverter 121 can be any suitable type such as MOSFETs (Metal Oxide Semiconductor Field Effect Transistors), IGBT (Insulated-Gate Bipolar Transistor), BJT (Bipolar Junction Transistors), etc. Note further that embodiments herein not only work for three phase motor control for PMSM (Permanent Magnet Synchronous Motor), BLDC (Brushless DC Motor), or ACIM (AC Induction Motor) motors, but also work for other types of motor control, e.g., H-bridge brushed or brushless motor control, step motor control, etc., where accurate current sensing is desired.

Thus, the current sense switch Q11 can be configured to produce an output current idc (a.k.a., signal), which is proportional (by a factor K) to the drain current ID when the corresponding switch Q11 is ON (that is, the gate source voltage supplied by the signal Vg1 is above the threshold voltage).

As a more specific example, a magnitude of the current ID=a magnitude of the current idc multiplied by the constant K which can be any suitable value. The magnitude of current IS is substantially equal to or equal to a magnitude of the current ID.

Since idc is a small portion of ID, the resistor R1 can be configured with a high resistance value to convert the current idc to a suitable voltage VR1=(idc*R1) for the analog-to-digital converter 141. For a BLDC trapezoidal motor control application, the results of converting the current idc can be used as the motor phase current for OCP (over-current protection), motor speed control or current control. More specifically, the controller 140 can be configured to receive the input control signal indicating a desired speed in which to control rotating of a shaft 134 of the motor 130. Based on monitoring of the magnitude of the current through each of the windings 131 of the motor 130 as discussed herein, the controller 140 adjusts the pulse width modulation of the control signals 107 such that the shaft 134 rotates at a desired speed or direction.

Note that the three-phase inverter 110 can be configured to use normal power MOSFETs (metal oxide field effect transistors) for high-side (Q1, Q2, Q3) and low-side switches (Q4, Q5, Q6) in conjunction with use of the switch Q11 (with current monitor capability). Alternatively, each of the low-sides switches Q4, Q5, and Q6 can be implemented using a respective instance of the current monitor switch Q11 as an alternative to implementing only a single switch Q11 are shown in FIG. 1. See another example of the switch Q11 FIG. 2.

Referring again to FIG. 1, as previously discussed, the controller 140 can be configured to use the current sensing associated with detected current ID (or current idc) as a feedback mechanism to subsequently control the PWM operation (such as generation of the pulses modulation signals 106) which are subsequently used via the driver 140-2 and the driver 140-3 to produce the switch control signals 107 applied directly to the gates of the switches Q1 through Q6 in the inverter 110 and the switch Q11.

FIG. 2 is a more detailed example diagram illustrating a current monitoring switch as discussed herein.

In this example, the implementation of the switch Q11 (switch circuitry) includes switch circuitry Q11-1, switch circuitry Q11-2, and operational amplifier 240.

In one example, the switch circuitry Q11-1 is one or more field effect transistors disposed in parallel; the switch circuitry Q11-2 is one or more field effect transistors disposed in parallel.

The operational amplifier 240 is powered by the input voltage 220 (a.k.a., V_{CC}).

As previously discussed, the switch Q11 includes at least nodes N1, node N2, node N3, and node N5.

The drain node D of the switch circuitry Q11-1 is directly connected to the node N1; the source node S of the switch Q11-1 is directly connected to the node N2; the gate node G of the switch circuitry Q11-1 is directly connected to the node N5. The drain node D of the switch circuitry Q11-2 is directly connected to the node N1; the source node S of the switch Q11-2 is directly connected to the inverting input node (−) of the operational amplifier 240; the gate node G of the switch circuitry Q11-2 is directly connected to the node N5.

During operation, as previously discussed, the control signal Vg1 controls activation and deactivation of the switch Q11-1 and switch Q11-2.

For example, when the control signal Vg1 supplied to the input node N5 is set to a high state with respect to the source node S, the switch Q11-1 is activated to an ON-state, providing a low impedance path drain node of the switch Q11-1 and the source node of the switch Q11-1 and also allowing flow of the current ID through the switch Q11 and the switch circuitry Q11-1 from the node N1 to the node N2.

Activation of the switch Q11-1 to an ON-state also results in activation of the switch Q11-2 to an ON-state. In such an instance, when currents ID flows through the switch Q11 from the node N1 to the node N2, the operational amplifier 240 produces the output current idc (a.k.a., signal) outputted from the node N3. A magnitude of the output current idc outputted from the node N3 is proportional to a magnitude of the current ID. For example, a magnitude of the current ID is equal to K multiplied by a magnitude of the current idc.

When the control signal Vg1 is set to a logic low with respect to the node N2, both the switch circuitry Q11-1 and the switch circuitry Q11-2 are deactivated to OFF states. In such an instance, substantially 0 current flows between the node N1 and N2. In other words, the magnitude of the current ID is substantially 0 amps. The magnitude of the current idc is also substantially 0 amps.

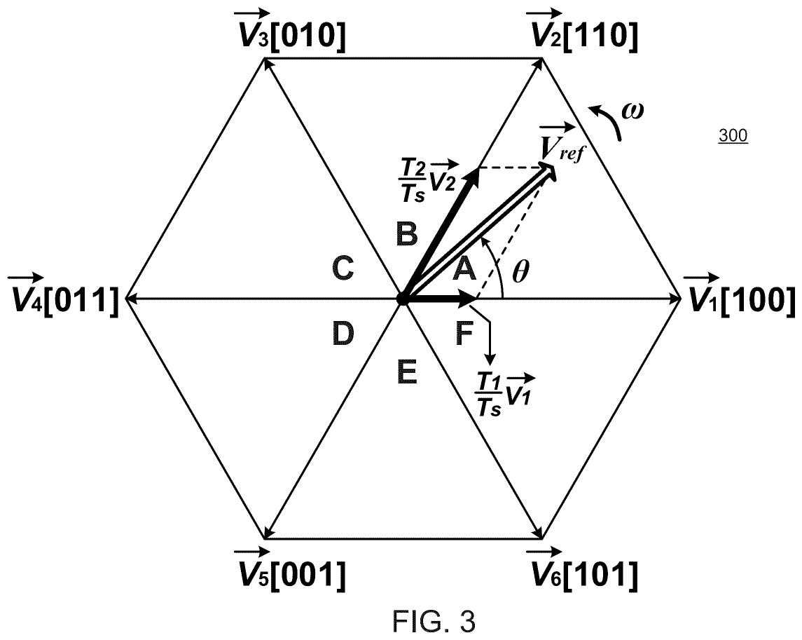

FIG. 3 is an example diagram of a space vector modulation for motor control as discussed herein.

In this example, the space sector modulation diagram 300 illustrates implementing multiple sequential control states associated with the inverter 110 such as control states 100, 110, 010, 011, 001, and 101 for FOC (Field-Oriented Control).

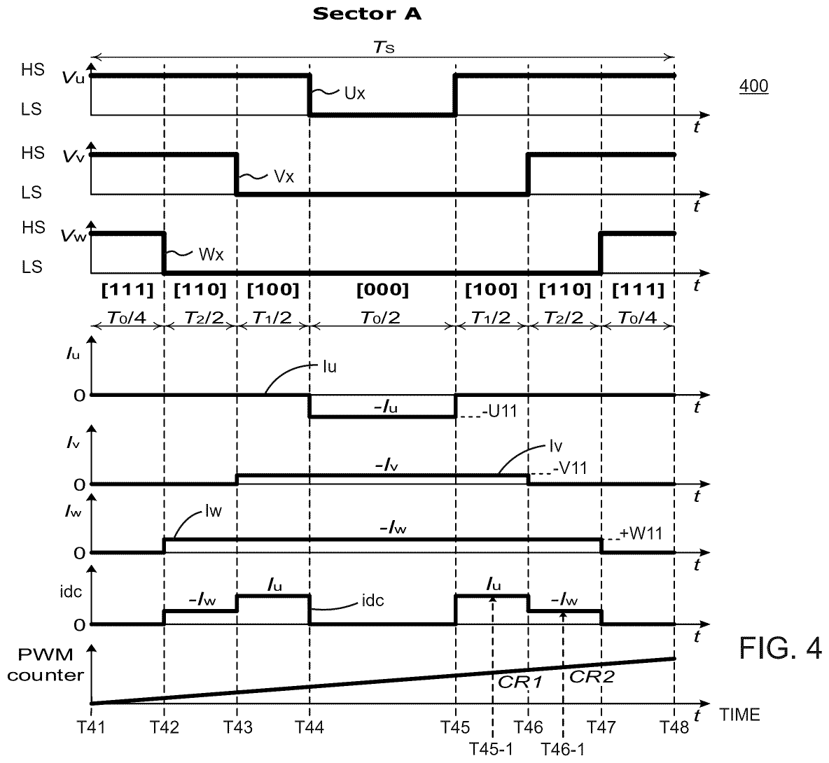

FIG. 4 is an example timing diagram illustrating pulse width modulation switch control and current sensing via space vector modulation discussed herein.

In this example, the timing diagram 400 illustrates different states of controlling the switches in the inverter 110 and monitoring of a respective current ID. In general, the PWM and current samplings for the current sense switch Q11 are shown in FIG. 4, such as using SVM (Space Vector Modulation) sector A (as shown in FIG. 3) as an example.

In this example, as shown in FIG. 4, at least the current of two motor phases (current iU through winding 131-1 and current iW through winding 131-2) can be measured by analog-to-digital converter 141. In such an instance, the third phase current iW through the winding 131-3 can be calculated from the two measured phases due to iU+iV+iW=0. For example, current iW=−(iV+iU). The wide bandwidth and high slew-rate amplifier (such as operational amplifier 240) as integrated in the switch Q11 supports accurate three-phase current determination.

More specifically, in this example for sector A of the SVM operation, the controller 140 produces the control signal Ux to be a logic high between time T41 and time T44; the controller 140 produces the control signal Ux to be a logic low between time T44 and time T45; the controller 140 produces the control signal Ux to be a logic high between the time T45 and time T48.

It is noted that when the signal Ux is a logic high (such as between time T41 and time T44 as well as between time T45 and time T48), the controller 140 produces the control signal Uh to be a logic high and the control signal Ul to be a logic low (in which case the switch Q1 is in an ON-state and the switch Q4 is an OFF-state). Conversely, it is noted that when the signal Ux is a logic low (such as between time T44 and time T45), the controller 140 produces the control signal Uh to be a logic low and the control signal Ul to be a logic high (in which case the switch Q1 is in an OFF-state and the switch Q4 is an ON-state).

The signal Iu in the timing diagram 400 indicates an amount of current flowing through the winding 131-1 (winding U). For example, the magnitude of the current Iu through the winding 131-1 is substantially 0 between time T41 and time T44 as well as between time T45 and time T48 for sector A. The amount of current Iu between time T44 and time T45 is −U11.

The controller 140 produces the control signal Vx to be a logic high between time T41 and time T43; the controller 140 produces the control signal Vx to be a logic low between time T43 and time T46; the controller 140 produces the control signal Vx to be a logic high between the time T46 and time T48. It is noted that when the signal Vx is a logic high (such as between time T41 and time T43 as well as between time T46 and time T48), the controller 140 produces the control signal Vh to be a logic high and the control signal Vl to be a logic low (in which case the switch Q2 is in an ON-state and the switch Q5 is an OFF-state). Conversely, it is noted that when the signal Vx is a logic low (such as between time T43 and time T46), the controller 140 produces the control signal Vh to be a logic low and the control signal Vl to be a logic high (in which case the switch Q2 is in an OFF-state and the switch Q5 is an ON-state).

The signal Iv in the timing diagram 400 indicates an amount of current flowing through the winding 131-2 (winding V). For example, the magnitude of the current Iv through the winding 131-2 is substantially 0 between time T41 and time T43 as well as between time T46 and time T48 for sector A. The amount of current Iv between time T43 and time T46 is −Iv of magnitude V11.

The controller 140 produces the control signal Wx to be a logic high between time T41 and time T42; the controller 140 produces the control signal Wx to be a logic low between time T42 and time T47; the controller 140 produces the control signal Wx to be a logic high between the time T47 and time T48. It is noted that when the signal Wx is a logic high (such as between time T41 and time T42 as well as between time T47 and time T48), the controller 140 produces the control signal Wh to be a logic high and the control signal Wl to be a logic low (in which case the switch Q3 is in an ON-state and the switch Q6 is an OFF-state). Conversely, it is noted that when the signal Wx is a logic low (such as between time T42 and time T47), the controller 140 produces the control signal Wh to be a logic low and the control signal Wl to be a logic high (in which case the switch Q3 is in an OFF-state and the switch Q6 is an ON-state).

The signal Iw in the timing diagram 400 indicates an amount of current flowing through the winding 131-3 (winding W). For example, the magnitude of the current Iw through the winding 131-3 is substantially 0 between time T41 and time T42 as well as between time T47 and time T48 for sector A. The amount of current or magnitude Iw between time T42 and time T47 is +W11.

As further shown, the timing diagram 400 indicates a magnitude of the current idc outputted from the switch Q11 to and through the resistor R1. The magnitude of the current through the winding 131-1 is determined based upon sampling the current idc (via sampling the voltage VR1 at time T45-1). For example, Iu+Iv+Iw=0. idc(T45-1)=VR1(T45-1)/R1. ID(T45-1)=idc(T45-1)*K=Iu(T45-1).

The magnitude of the current through the winding 131-2 is determined based upon sampling the current idc (via sampling the voltage VR1 at time T46-1). For example, Iu+Iv+Iw=0. idc(T46-1)=VR1(T46-1)/R1. ID(T46-1)=idc(T46-1)*K=Iw(T46-1).

The magnitude of the current through the winding 131-3 is determined as follows: Iu+Iv +Iw=0. Iv=−(Iu+Iw)=−[ID(T46-1)+ID(T45-1)].

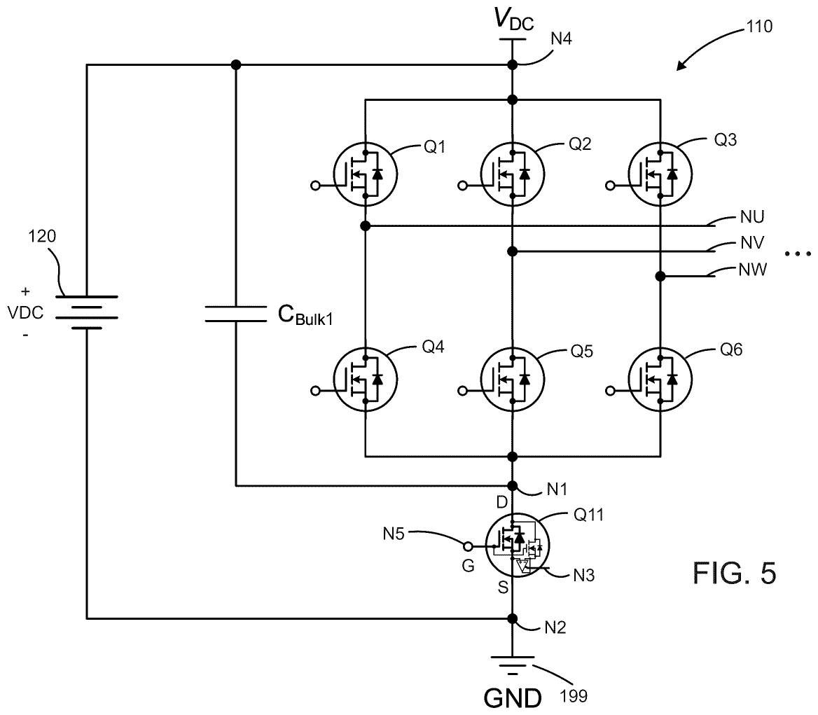

FIG. 5 is an example circuit diagram illustrating connectivity of switches, capacitors, and battery associated with a switch control circuit as discussed herein.

In this example, a combination of the inverter 110 and switch Q11 is a series circuit path connected between the node N4 and the node N2 (such as ground reference voltage 199) associated with the input voltage resource 120. The node N1 provides direct connectivity of the inverter 110 to the switch Q11. The capacitor CBULK1 is directly connected between the node N4 and the node N1.

The relative position of voltage source 120 (such as a battery or other suitable entity), dc-link bulk capacitor CBulk1 of the three-phase inverter 110, and current sense switch Q11 are shown in FIG. 5. As shown in FIG. 5, the current sense switch Q11 can be configured to censor monitor the average battery current and the average motor current, so it is suitable for BLDC trapezoidal motor control.

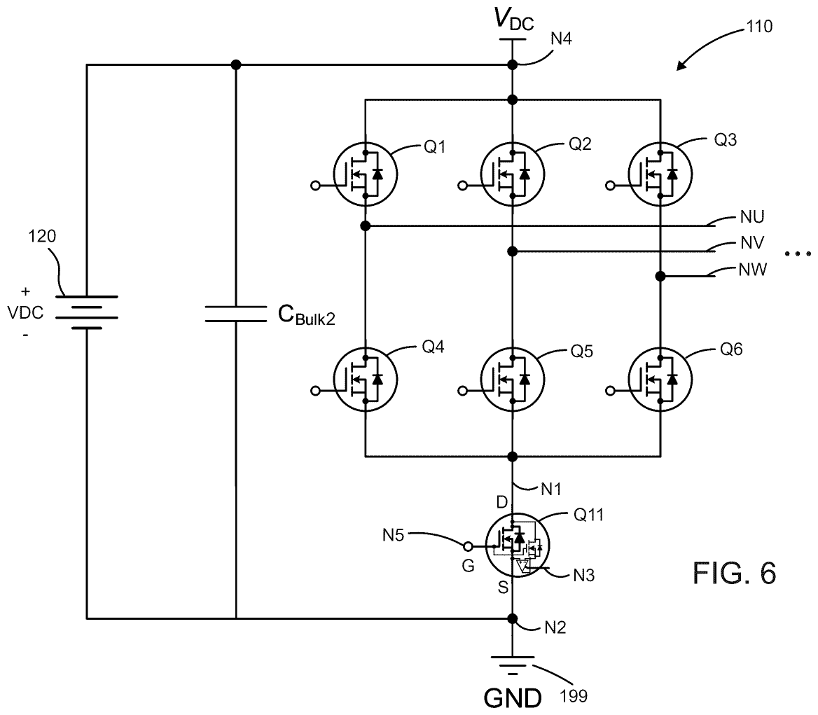

FIG. 6 is an example circuit diagram illustrating connectivity of switches, capacitors, and battery associated with a switch control circuit as discussed herein.

In this example, a combination of the inverter 110 and switch Q11 is a series circuit path connected between the node N4 and the node N2 (such as ground reference voltage 199) associated with the input voltage resource 120. The node N1 provides direct connectivity of the inverter 110 to the switch Q11. The capacitor CBULK2 is directly connected between the node N4 and the node N1.

The relative position of the input voltage source 120, dc-link bulk capacitor CBulk2, and current sense switch Q11 are shown in FIG. 6. As shown in FIG. 6, the current sense switch Q11 senses (monitors) the instantaneous motor phase current, so it is more suitable for the three-phase current construction of an FOC motor control.

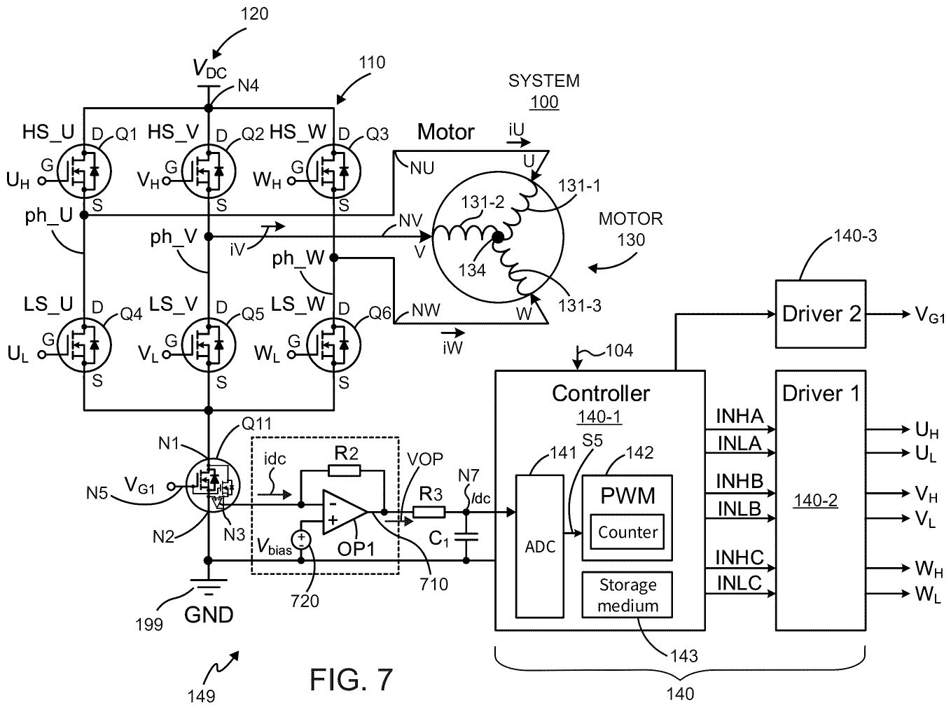

FIG. 7 is an example diagram illustrating implementation of a current monitor circuit as discussed herein.

In this example, the monitor circuit 149 includes operational amplifier OP1, resistor R2, resistor R3, and capacitor C1. The node N3 of the switch Q11 is directly connected to the inverting input node (−) of the operational amplifier OP1; the resistor R2 is directly connected between the node N3 and the output node 710 of the operational amplifier OP1; the resistor R3 is directly connected between the output node 710 of the operational amplifier OP1 and the input node N7 of the analog-to-digital converter 141; the capacitor C1 is directly connected between the node N7 and the ground reference node 199; the voltage bias source 720 produces the bias voltage Vbias inputted to the noninverting input node (+) of the operational amplifier OP1.

As previously discussed, the node N3 outputs the current idc, which flows through the resistor R2. The voltage VOP at the output node 710 of the operational amplifier OP1 is as follows: VOP=Vbias+(idc*R2). idc=(VOP−Vbias)*R2.

It is further noted that the combination of the resistor R3 in the capacitor C1 is an RC filter to produce a filtered voltage VOP inputted to the node N7. Signal S5 is a digital value indicating a magnitude of filtered voltage VOP.

Accordingly, the implementation of the system 100 FIG. 7 shows the schematics of current sense FET in dc-link current sensing, with a current to voltage converter (Vbias voltage reference, operational amplifier OP1, and resistor R1). The Vbias voltage reference can be implemented by any suitable circuit such as a resistive voltage divider, a linear regulator, operational amplifier, etc. The current to voltage converter supporting conversion of the current idc to a digital signal S5 can be any implementation suitable for a specific application. The current to voltage converter can be used to implement any of the current sense FET operations in this invention disclosure document. Note further that the current to voltage converter as discussed herein can be integrated to the current sense FET so that the current sense FET outputs a voltage value (instead of current idc), where the outputted voltage value is proportional to the MOSFET drain current ID when the switch Q11 is ON.

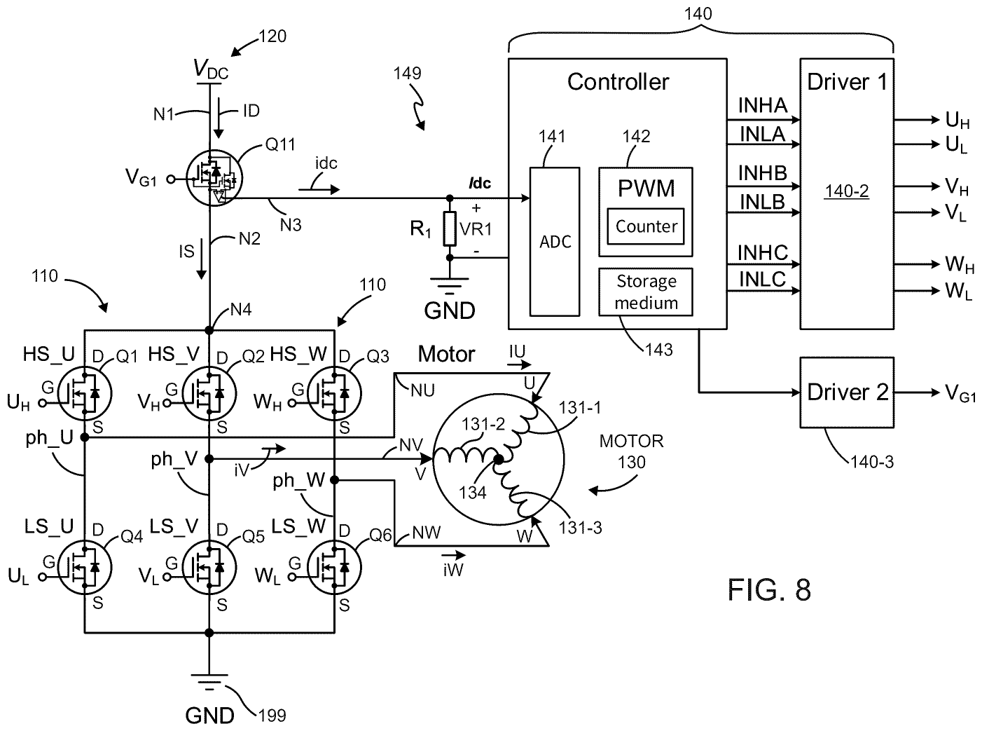

FIG. 8 is an example diagram illustrating implementation of the current monitor circuit discussed herein.

As shown in FIG. 8, the switch Q11 can be implemented in series between the input voltage source 120 and the inverter 110. In a similar manner as previously discussed, the input voltage source 120 supplies the voltage VDC. However, in this example, the input voltage source 120 supplies the input voltage VDC to the node N1 of the switch Q11. The controller 140 produces the control signal Vg1 to control operation of the switch Q11. Node N3 of the switch Q11 outputs the current idc to the resistor R1. The analog-to-digital converter 141 converts the voltage VR1 across the resistor R1 to determine a magnitude of the current IDC supplied to the inverter 110. Note again that the current IS supplied by the from the source node S of the switch Q11 to the node N4 is substantially equal to or equal to current ID.

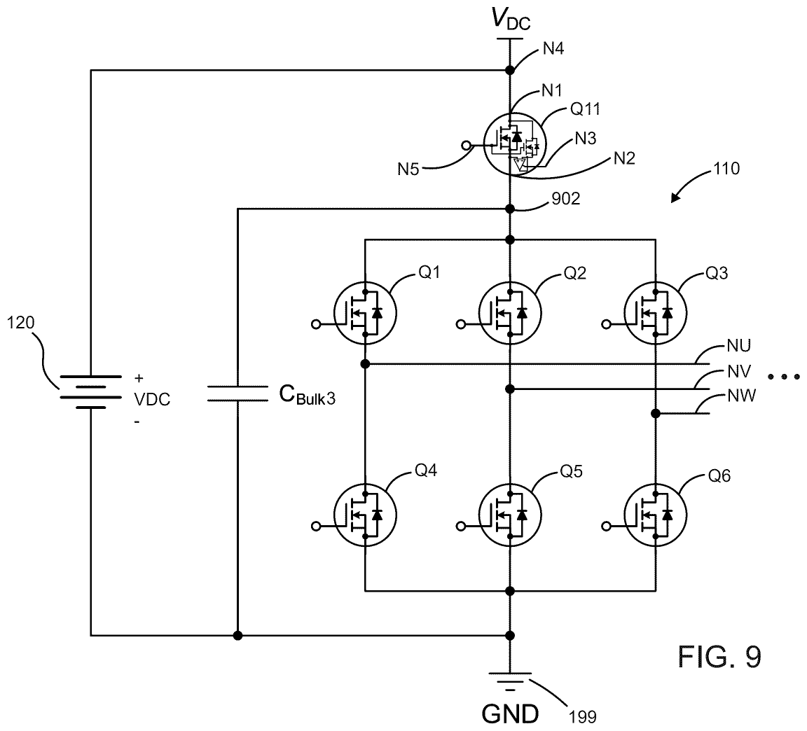

FIG. 9 is an example circuit diagram illustrating connectivity of switches, capacitors, and battery associated with a switch control circuit as discussed herein.

Similarly, the relative positions of the input voltage source, the bulk capacitor CBulk, the three-phase inverter, and the switch Q11 is shown in FIG. 9. In such an instance, the current sense switch Q11 and corresponding monitor circuit 149 senses or monitors the average current. Such an example of implementing the motor system 100 may be suitable for BLDC trapezoidal motor control.

Thus, in this example, a combination of the inverter 110 and switch Q11 is a series circuit path connected between the node N4 and the ground reference voltage 199 associated with the input voltage source 120. The node 902 provides direct connectivity of the node N2 of the switch Q11 to the inverter 110. The capacitor CBULK3 is directly connected between the node N4 and the node 902.

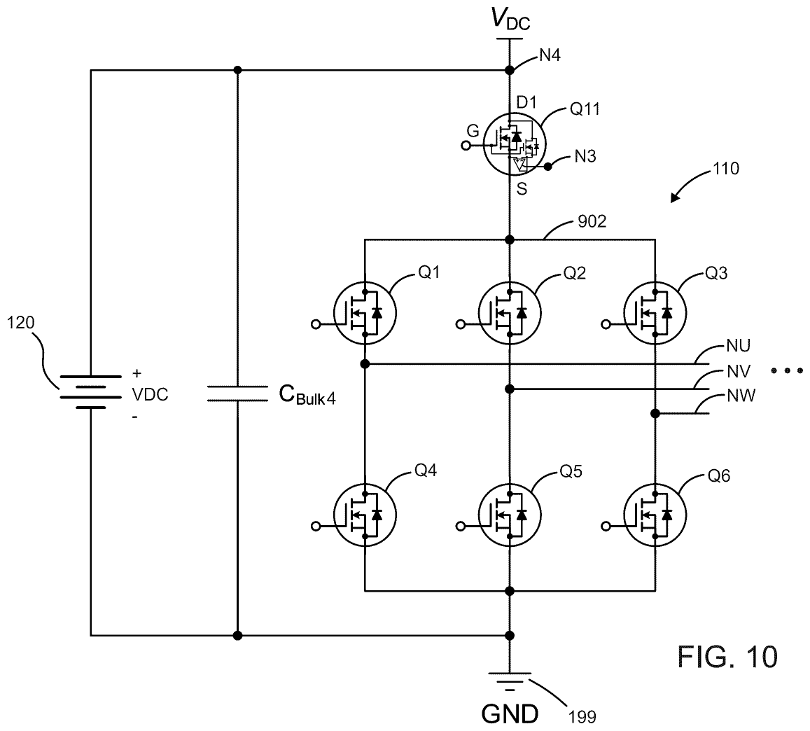

FIG. 10 is an example circuit diagram illustrating connectivity of switches, capacitors, and input voltage source (such as battery) associated with a switch control circuit as discussed herein.

In FIG. 10, the current sense FET is sensing the instantaneous motor phase current, which may be suitable for the three-phase current construction of FOC motor control.

More specifically, in this example, a combination of the switch Q11 and the inverter 110 is a series circuit path connected between the node N4 and the node N2 (such as ground reference voltage 199) associated with the battery resource 120. The node 902 provides direct connectivity of the switch Q11 to the inverter 110. The capacitor CBULK4 is directly connected between the node N4 and the node N1.

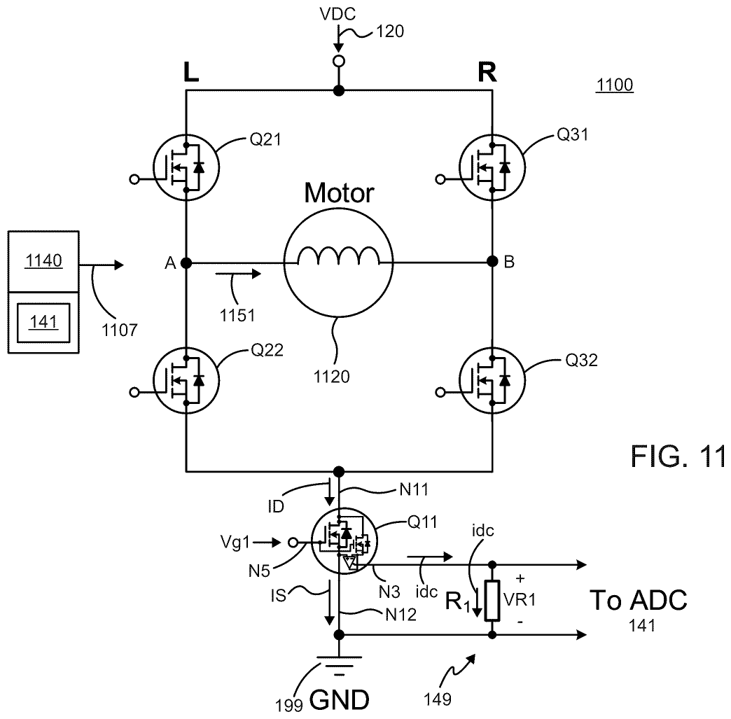

FIG. 11 is an example diagram illustrating a motor control system including a switch monitor circuit as discussed herein.

In general, FIG. 11 shows the schematics of current sense FET in an H-bridge motor control. The current sense FET is used in place of a normal low-side (or high-side) dc-link shunt resistor to sense the current of the brushed or brushless motor. The H-bridge power can be completely switched off by the current sense FET Q1. Note that the current IS supplied by the from the source node S of the switch Q11 to the ground reference 199 is substantially equal to or equal to current ID.

More specifically, in this example, the motor system 1100 includes motor 1120, switch Q21, switch Q22, switch Q31, switch Q32, and switch Q11.

The controller 1140 and corresponding circuitry produces the respective control signals 1107 to control operation of the different switches Q21, Q22, Q31, and Q32. Controlled operation of the different switches controls a flow of current through the respective winding of the motor 1120, resulting in a corresponding rotation of the shaft of the motor 1120.

For example, the controller 1140 can be configured to simultaneously activate the switch Q21 and the switch Q32 (while switch Q22 and switch Q31 are simultaneously OFF) as well as activation of the switch Q11 to an ON-state during a first portion of a motor control cycle to cause the flow of current 1151 through the winding of the motor 1120 from node A to node B.

Conversely, the controller 1140 can be configured to simultaneously activate the switch Q31 and the switch Q22 (while switch Q21 and switch Q32 are simultaneously OFF) during a second portion of a motor control cycle to cause the flow of current 151 through the winding of the motor 1120 from node B to node A.

As previously discussed, the control flow of current through the motor 1120 causes a corresponding shaft of the motor 1120 to rotate.

Further, as previously discussed, the switch Q11 includes the node N3 to output the current idc to the resistor R1. Flow of current idc through the resistor R1 produces the voltage VR1, which is measured by the analog-to-digital converter 141 to determine a magnitude of the current ID conveyed from the node N11 through the switch Q11 to the node N12. Thus, the current 1151 and through the corresponding switch Q11 set to an ON-state enables determination of a magnitude of the current 1151 through the motor 1120.

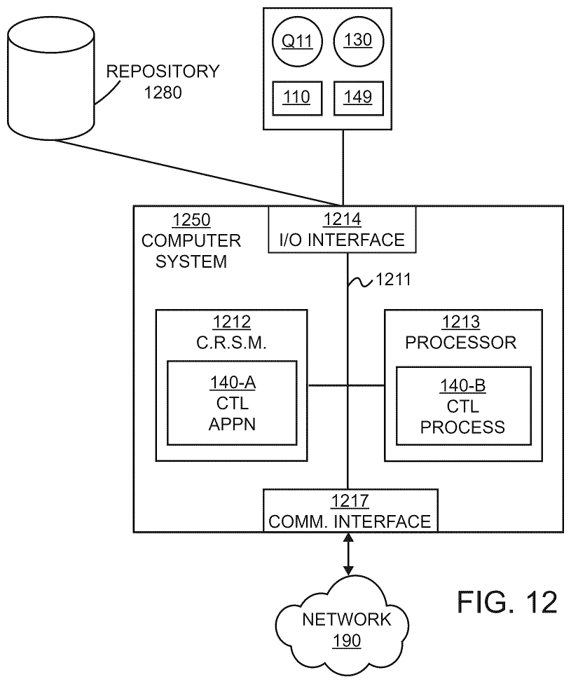

FIG. 12 is an example block diagram of a computer system for implementing any of the operations as previously discussed according to examples herein.

Any of the resources (such as controller 140, etc.) as discussed herein can be configured to include computer processor hardware and/or corresponding executable instructions to carry out the different operations as discussed herein.

For example, as shown, computer system 1250 of the present example includes an interconnect 1211 that couples computer readable storage media 1212 or computer-readable storage hardware such as a non-transitory type of media (which can be any suitable type of hardware storage medium in which digital information can be stored and retrieved), a processor 1213 (computer processor hardware), I/O interface 1214, and a communications interface 1217.

I/O interface(s) 1214 supports connectivity to the components such as switch Q11, inverter 110, etc., of the motor system 100.

Computer readable storage medium 1212 can be any hardware storage device such as memory, optical storage, hard drive, floppy disk, etc. In one example, the computer readable storage medium 1212 stores instructions and/or data.

As shown, computer readable storage media 1212 can be encoded with controller application 140-A (e.g., including instructions) to carry out any of the operations as discussed herein.

During operation of one example, processor 1213 accesses computer readable storage media 1212 via the use of interconnect 1211 in order to launch, run, execute, interpret or otherwise perform the instructions in controller application 140-A stored on computer readable storage medium 1212. Execution of the controller application 140-A produces controller process 140-B to carry out any of the operations and/or processes as discussed herein.

Those skilled in the art will understand that the computer system 1250 can include other processes and/or software and hardware components, such as an operating system that controls allocation and use of hardware resources to execute controller application 140-A.

In accordance with different examples, note that computer system may reside in any of various types of devices, including, but not limited to, a power supply, switched-capacitor converter, power converter, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1250 may reside at any location or can be included in any suitable resource in any network environment to implement functionality as discussed herein.

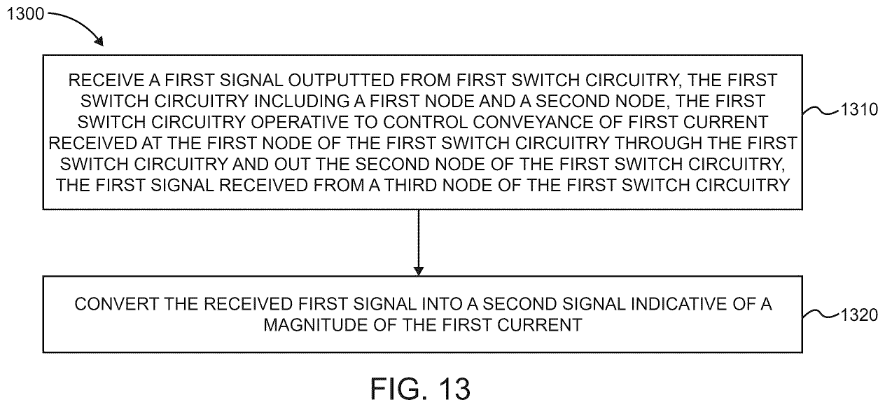

Functionality supported by the different resources will now be discussed via flowchart in FIG. 13. Note that the operations in the flowchart below can be executed in any suitable order.

FIG. 13 is a flowchart 1300 illustrating an example method according to examples herein. Note that there will be some overlap with respect to concepts as discussed above.

In processing operation 1310, the switch circuitry Q11 receives a first current signal ID. The switch circuitry Q11 includes a first node (such as a source node S) and a second node (such as a drain node D). The first switch circuitry Q11 controls conveyance of the first current ID received at the first node D (drain node) of the first switch circuitry Q11 through the first switch circuitry Q11 and out the second node S (source node) of the first switch circuitry Q11. In one example, the controller 140 receives the signal idc from the output node N3 of the first switch circuitry.

Via the analog-to-digital converter 141, the controller application 140-1 converts the received current idc (and corresponding generated voltage VR1 across the resistor R1) into a second signal (such as voltage VR1), where a magnitude of the voltage VR1 is indicative of a magnitude of the first current idc. For example, the magnitude of the current idc is equal to VR1 divided by a resistance of resistor R1. As previously discussed, it is known that the current idc through the resistor R1 is proportional to the current ID conveyed through the switch Q11 from the node N1 to the node N2. The magnitude of the current idc therefore indicates a magnitude of the current ID. The controller 140 determines the current idc based on the equations: idc=VR1/R1 and ID=idc×P1, where the proportion value P1 is a known value. Based on the determined magnitude of the current ID as indicated by the digital signal S5, the pulse width modulator 142 of the controller 140-1 modulates the control signals 107 to control the amount of current through each of the windings 131 of the motor 130.

Note again that techniques herein are well suited for use in current monitoring and/or motor control applications. However, it should be noted that examples herein are not limited to use in such applications and that the techniques discussed herein are well suited for other applications as well.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. An apparatus comprising:
first switch circuitry including a first node and a second node, the first node operative to receive first current, the first switch circuitry operative to control conveyance of the first current received at the first node through the first switch circuitry and out the second node of the first switch circuitry; and
a monitor circuit operative to: i) receive a first signal outputted from a third node of the first switch circuitry, and ii) produce a second signal indicative of a magnitude of the first current.

2. The apparatus as in claim 1, wherein the first signal is second current: i) received at the first node of the first switch circuitry, ii) conveyed through the first switch circuitry during a condition in which the first switch circuitry is ON, and iii) outputted from the third node to the monitor circuit.

3. The apparatus as in claim 2, wherein a magnitude of the second current is proportional to a magnitude of the first current.

4. The apparatus as in claim 1, wherein the first switch circuitry is a cut-off switch or protection switch, control of the first switch circuitry operative to disconnect an inverter from a battery source during a condition in which the first switch circuitry is operated in an OFF-state.

5. The apparatus as in claim 1, wherein the first signal is a second current proportional to the first current; and
wherein the monitor circuit is operative to produce the second signal based on a voltage produced by flow of the second current through a resistor.

6. The apparatus as in claim 5, wherein the monitor circuit includes an analog-to-digital converter operative to convert the voltage into a digital value indicative of a magnitude of the first current.

7. The apparatus as in claim 1, wherein the first signal is a second current in which a magnitude of the second current is proportional to a magnitude of the first current; and
wherein the monitor circuit includes an amplifier circuit operative to: i) convert the second current into a voltage signal, and ii) apply an offset to the voltage signal.

8. The apparatus as in claim 7, wherein the monitor circuit further includes:
filter circuitry to filter the voltage signal; and
an analog-to-digital converter operative convert the filtered voltage signal into a digital value indicative of a magnitude of the first current.

9. The apparatus as in claim 1, wherein the first switch circuitry is disposed in series with second switch circuitry; and
wherein the second switch circuitry is operative to control conveyance of the first current through at least one winding of a motor.

10. The apparatus as in claim 9, wherein the second switch circuitry is operative to receive the first current from a voltage source and output the first current to the first node of the first switch circuitry.

11. The apparatus as in claim 10 further comprising:
a capacitor disposed in parallel with the second switch circuitry; and
wherein a combination of the capacitor and the second switch circuitry is disposed in series with the first switch circuitry.

12. The apparatus as in claim 10 further comprising:
a capacitor disposed in parallel with a series combination of the first switch circuitry and the second switch circuitry.

13. The apparatus as in claim 9, wherein the first switch circuitry is operative to receive the first current at the first node from a voltage source and supply the first current through the second node to the second switch circuitry.

14. The apparatus as in claim 13 further comprising:
a capacitor disposed in parallel with the second switch circuitry; and
wherein a parallel combination of the capacitor and the second switch circuitry is disposed in series with the first switch circuitry.

15. The apparatus as in claim 13 further comprising:
a capacitor disposed in parallel with a series combination of the first switch circuitry and the second switch circuitry.

16. The apparatus as in claim 1, wherein the first switch circuitry includes:
a first switch including a first gate node, a first drain node, and a first source node;
a second switch including a second gate node, a second drain node, and a second source node;
an operational amplifier;
wherein the first gate node is directly connected to the second gate node;
wherein the first drain node is directly connected to the second drain node;
wherein the operational amplifier is operative to generate the first signal outputted from the third node of the first switch circuitry based on a first voltage at the first source node and a second voltage at the second source node.

17. The apparatus as in claim 16, wherein the operational amplifier is configured to operate in a buffer mode in which an output of the operational amplifier is directly connected to the second source node.

18. A controller operative to control operation of: i) the first switch circuitry as in claim 1, and ii) second switch circuitry directly coupled to the first switch circuitry.

19. A method comprising:
receiving a first signal outputted from first switch circuitry, the first switch circuitry including a first node and a second node, the first switch circuitry operative to control conveyance of first current received at the first node of the first switch circuitry through the first switch circuitry and out the second node of the first switch circuitry, the first signal received from a third node of the first switch circuitry; and
converting the received first signal into a second signal indicative of a magnitude of the first current.

20. The method as in claim 19, wherein the first signal is second current: i) received at the first node of the first switch circuitry, ii) conveyed through the first switch circuitry, and iii) outputted from the third node to the monitor circuit.
